(19) United States
(12) Patent Application Publication
(10) Pub. No.: US 2021/0249936 A1
(43) Pub. Date: Aug. 12, 2021

(54) CLOSED-CYCLE HEAT DISSIPATION STRUCTURE OF MOTOR

(71) Applicant: GRENERGY OPTO, INC., Hsinchu City (TW)

(72) Inventors: SHAN-NAN CHEN, Hsinchu City (TW); SHENG-WEN CHEN, Hsinchu City (TW)

(21) Appl. No.: 16/889,360

(22) Filed: Jun. 1, 2020

(30) Foreign Application Priority Data
Feb. 6, 2020 (TW) 109103721

(51) Int. Cl. H02K 9/20; H02K 9/22

(52) U.S. Cl. CPC H02K 9/20; H02K 9/22

(57) ABSTRACT

A closed-cycle heat dissipation structure of a motor is provided. The motor includes a shell. The closed-cycle heat dissipation structure includes a plurality of thermal conduction members and a heat dissipation device. Each of the thermal conduction members defines two ends thereof as a heat absorbing end and a cooling end. The heat absorbing end of each of the thermal conduction members is connected to a stator of the motor, and the cooling end of each of the thermal conduction members penetrates the shell of the motor and extends out of the shell. The heat dissipation device is disposed outside of the shell of the motor, and the cooling end of each of the thermal conduction members is connected to the heat dissipation device.

### CROSS-REFERENCE TO RELATED PATENT APPLICATION

This application claims the benefit of priority to Taiwan Patent Application No. 109103721, filed on Feb. 6, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a closed-cycle heat dissipation structure of a motor, and more particularly to a closed-cycle heat dissipation structure for cooling an electrical motor.

### BACKGROUND OF THE DISCLOSURE

Internal combustion engines are power sources of conventional vehicles. However, since the supply of fossil fuel will gradually be depleted in the future and the fossil fuel results in air pollution and carbon dioxide emission, electric vehicles gradually have received an increasing amount of attention and have become more popular in the market.

In the electric vehicles, the internal combustion engines are replaced by motors as the power sources. In the past, the electric vehicles were limited by the battery storage capacity and the motor output power so that the endurance and the power performance of the electric vehicles were worse than the vehicles with the internal combustion engines, and the electric vehicles were not as easily accepted in the market. However, in recent years, with the improvement of battery technologies and motor technologies, the endurance and the power performance of the electric vehicles have exceeded those of the vehicles with the internal combustion engines, so that the electric vehicles have gradually become popular in the market. Since the power of the electric vehicles has increased, the motors in operation generate more heat, so that heat dissipation abilities of the motors needs to be improved.

The heat generated by the motor in operation primarily results from a copper loss, an iron core loss, a wind resistance loss, and a friction loss of a bearing of the motor. The copper loss results from a current flowing through a plurality of coils of a stator of the motor, the iron core loss results from an alternating magnetic flux passing through an iron core of the stator, and the wind resistance loss and the friction loss result from a rotor in rotation. Conventional motor cooling technique substantially includes a passive air-cooling technique, a forced wind-cooling technique, and a water cooling technique. In the passive air-cooling, a plurality of heat dissipation fins are disposed on a shell of the motor so that air flows through the heat dissipation fins to provide cooling effects. In the forced wind-cooling technique, a fan is provided to force the air to flow through the motor to provide cooling effects. In the water cooling technique, the motor is enclosed in the shell, and a cooling fluid flows through the shell to provide cooling effects.

Although the conventional motor cooling techniques provide certain effects to improve the heat dissipation of the motor, the conventional motor cooling techniques have varying disadvantages as set forth below. For example, in the passive air-cooling technique, the motor can be only cooled from the surface of the motor, and a temperature of the stator and a temperature of the rotor inside of the motor cannot be effectively decreased. In the forced wind-cooling technique, a fan having a large volume is disposed so that a volume of the motor increases and a noise issue occurs. In the water cooling technique, a cooling structure is complicated and expensive so that the water cooling technique is not suitable for the electric vehicle having a small size. In addition, in a part of wind-cooling technique, an air hole must be disposed on the shell of the motor. However, the air hole breaks a sealing property of the motor, allowing water and impurities to easily enter into the shell of the motor, and a risk of short-circuit damage of the coils of the motor is increased.

### SUMMARY OF THE DISCLOSURE

In response to the above-referenced technical inadequacies, the present disclosure provides a closed-cycle heat dissipation structure of a motor to improve on the structural defects of the conventional heat dissipation structure of a motor.

In one aspect, the present disclosure provides a closed-cycle heat dissipation structure of a motor. The motor includes a shell, a stator disposed inside of the shell, and a rotor internally penetrating through the stator. The closed-cycle heat dissipation structure includes a plurality of thermal conduction members and a heat dissipation device. Each of the thermal conduction members defines two ends thereof as a heat absorbing end and a cooling end. The heat absorbing ends of the thermal conduction members are connected to the stator, and the cooling ends of the thermal conduction members penetrate through the shell of the motor and extend out of the shell. The heat dissipation device is disposed outside of the shell. The cooling ends of the thermal conduction members are connected to the heat dissipation device.

In certain embodiments of the present disclosure, the stator has an iron core surrounding an outer periphery of the rotor. The iron core has a plurality of winding portions at one side of the iron core facing toward the rotor, and a plurality of coils surrounding the winding portions. The iron core has an outer portion at one side of the iron core corresponding in position to the winding portions, and the heat absorbing ends of the thermal conduction members are connected to the outer portion.

In certain embodiments of the present disclosure, the iron core has a plurality of iron core blocks assembled into a ring shape, and the iron core blocks surround an outer periphery of the rotor. Each of the iron core blocks is provided with the winding portion, and each of the iron core blocks has the outer portion at one side thereof corresponding in position to the winding portion.

In certain embodiments of the present disclosure, the thermal conduction members are a plurality of heat pipes, the iron core has a plurality of connection grooves at the outer portions of the iron core, and the heat absorbing ends of the thermal conduction members are connected to the connection grooves. The shell has an end plate at one end of the shell corresponding in position to a shaft of the rotor, and the cooling ends of the thermal conduction members penetrate through the end plate and extend out of the end plate. The heat dissipation device is disposed outside of the end plate, and the cooling ends of the thermal conduction members are connected to the heat dissipation device.

Therefore, the closed-cycle heat dissipation structure of the present disclosure includes the effects as follows. Heat of the stator inside of the motor can be transferred to the heat dissipation device disposed outside of the shell of the motor through the thermal conduction members to be dissipated. Therefore, the motor can be cooled quickly and a heat accumulation inside of the motor can be prevented.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective assembled view of a closed-cycle heat dissipation structure of a motor of the present disclosure according to a first embodiment of the present disclosure.

FIG. 2 is a perspective exploded view of the closed-cycle heat dissipation structure of the motor of the present disclosure according to the first embodiment of the present disclosure.

FIG. 3 is an assembled sectional view of the closed-cycle heat dissipation structure of the motor of the present disclosure according to the first embodiment of the present disclosure.

FIG. 4 is a perspective assembled view of a stator and a plurality of thermal conduction members of the closed-cycle heat dissipation structure of the motor of the present disclosure according to the first embodiment of the present disclosure.

FIG. 5 is a partial exploded view of an iron core block and the thermal conduction member of the closed-cycle heat dissipation structure of the motor of the present disclosure according to the first embodiment of the present disclosure.

FIG. 6 is a sectional view of the iron core block of the closed-cycle heat dissipation structure of the motor of the present disclosure according to the first embodiment of the present disclosure.

FIG. 7 is a sectional view of the iron core block and the thermal conduction member of the closed-cycle heat dissipation structure of the motor of the present disclosure according to the second embodiment of the present disclosure.

FIG. 8 is an assembled view of the iron core block of the closed-cycle heat dissipation structure of the motor of the present disclosure according to the second embodiment of the present disclosure.

FIG. 9 is a perspective view of the iron core block of the closed-cycle heat dissipation structure of the motor of the present disclosure according to a third embodiment of the present disclosure.

FIG. 10 is a perspective exploded view of the iron core block of the closed-cycle heat dissipation structure of the motor of the present disclosure according to the third embodiment of the present disclosure.

FIG. 11 is a sectional view of the iron core block of the closed-cycle heat dissipation structure of the motor of the present disclosure according to the third embodiment of the present disclosure.

FIG. 12 is a sectional view of the iron core block along line XII-XII of

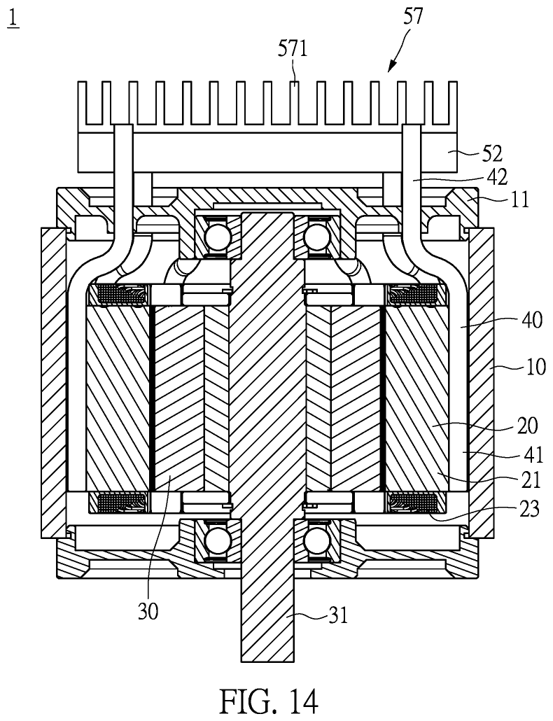

FIG. 11 of the closed-cycle heat dissipation structure of the motor of the present disclosure according to the third embodiment of the present disclosure.

FIG. 13 and FIG. 14 are assembled sectional views of the closed-cycle heat dissipation structure of the motor of the present disclosure according to a fourth embodiment of the present disclosure.

FIG. 15 is an assembled sectional view of the closed-cycle heat dissipation structure of the motor of the present disclosure according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

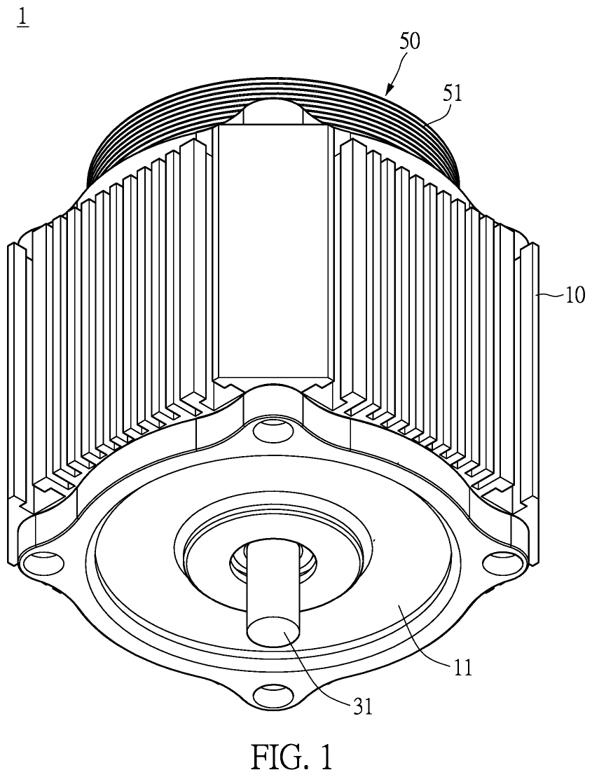

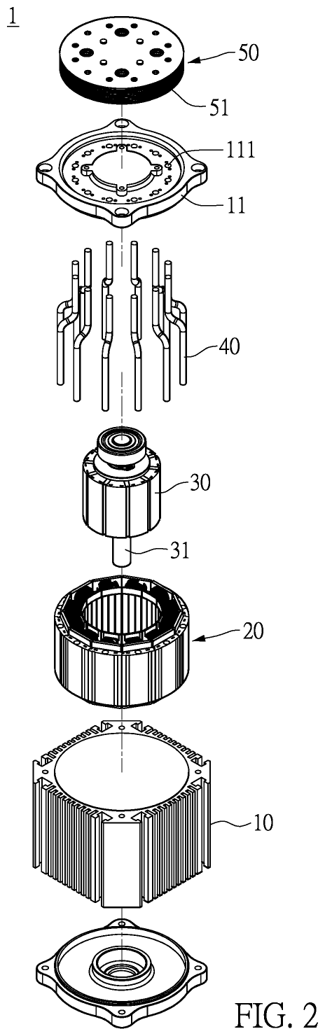

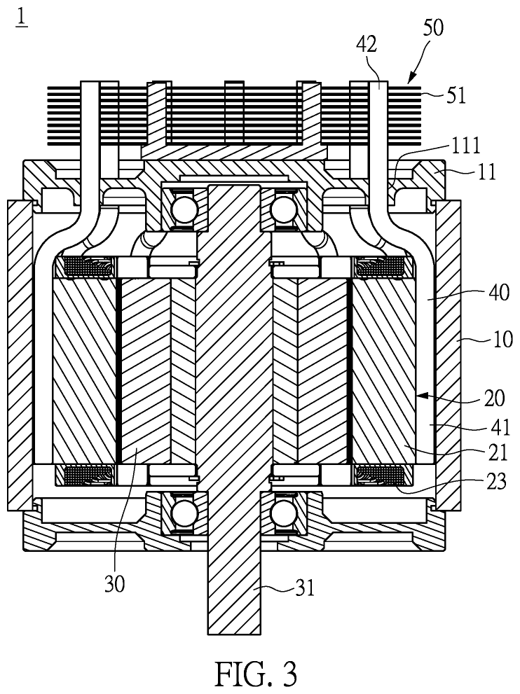

Referring to FIG. 1 to FIG. 3, the present disclosure provides a motor 1 having a closed-cycle heat dissipation structure. The motor 1 includes a shell 10, a stator 20 and a rotor 30 both disposed inside of the shell 10, a plurality of thermal conduction members 40 connected to the stator 20, and a heat dissipation device 50. Specifically, the stator 20 is disposed inside of the shell 10, and the rotor 30 penetrates through the stator 20. A plurality of coils 23 of the stator 20 with a current flowing through the coils 23 generate a rotating magnetic field, and the coils 23 and the rotor 30 generate a torque to drive the rotor 30 to rotate. One end of each of the thermal conduction members 40 is connected to the stator 20, and another end of each of the thermal conduction members 40 corresponding to the stator 20 penetrates out of an end plate 11 of the shell 10 and is connected to the heat dissipation device 50. Therefore, through the thermal conduction members 40, heat accumulated inside of the motor 1 can be quickly transferred to the heat dissipation device 50 so that the motor 1 in operation does not easily overheat.

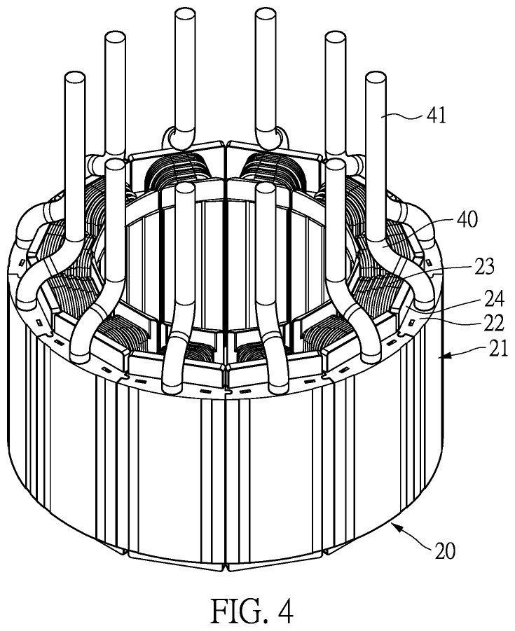

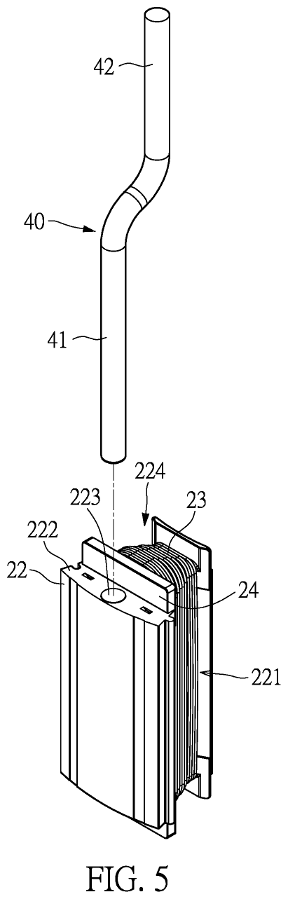

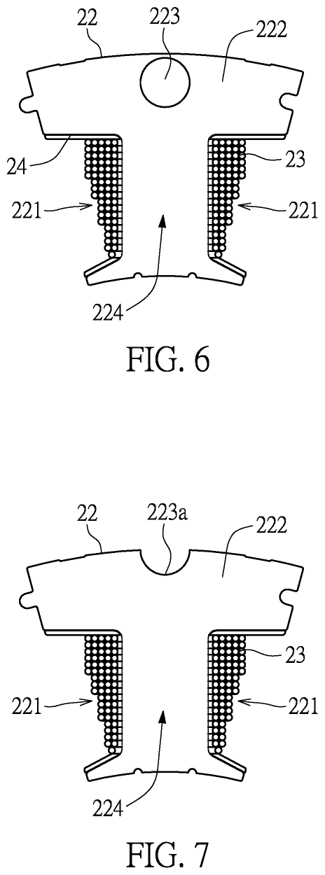

Referring to FIG. 4 to FIG. 6, the stator 20 has an iron core 21 surrounding an outer periphery of the rotor 30. The iron core 21 has a plurality of winding portions 224 formed at one side of the iron core 21 facing toward the rotor 30. Each of the winding portions 224 has two winding grooves 221 respectively disposed at two sides thereof. The coils 23 surround the winding grooves 221 to form a plurality of armatures. In each of the winding portions 224, an insulation sleeve 24 is disposed on the winding portion 224 and is disposed between the winding portion 224 of the iron block 22 and the coil 23 to prevent the coil 23 from being directly in contact with the iron core 21. As shown in FIG. 4 to FIG. 6, each of the iron core blocks 22 has an outer portion 222 at one side thereof away from the rotor 30. In each of the iron core blocks 22, the outer portion 222 protrudes from a top portion of the coil 23, and a connection groove 223 is disposed and extends from one end of the outer portion 222 to another end of the outer portion 222 along a longitudinal direction of the iron core 21.

It should be noted that in the present embodiment, the iron core 21 of the stator 20 is assembled by the iron core blocks 22 in an assembled structure, but the present disclosure is not limited thereto. In other embodiments, the iron core 21 can be formed in an integral structure.

In addition, a thermal conduction glue or a thermal conduction paste can be filled between an outer periphery of the iron core 21 of the stator 20 and an inner side wall of the shell 10. Therefore, heat of the stator 20 can be transferred to the shell 10 through the thermal conduction glue or the thermal conduction paste, so that the heat of the stator 20 and the rotor 30 inside of the motor 1 can be transferred to the shell 10.

Each of the iron core blocks 22 is connected to at least one of the thermal conduction members 40. Each of thermal conduction members 40 has a heat absorbing end 41 and a cooling end 42. In each of the thermal conduction members 40, the heat absorbing end 41 penetrates through the connection groove 223 of the iron core 22, and an outer side wall of the heat absorbing end 41 can be connected to an inner side wall of the connection groove 23 in a welding manner or an adhesive manner, or the thermal conduction glue or the thermal conduction paste can be coated between the outer side wall of the heat absorbing end 41 and the inner side wall of the connection groove 23, so that the thermal conduction member 40 and the connection groove 223 can be connected with each other, and heat of the iron core 21 can be transferred to the heat absorbing end 41 of the thermal conduction member 40.

More specifically, in the present embodiment, a cross-sectional surface of the heat absorbing end 41 of each of the thermal conduction members 40 is circular, an opening of the connection groove 223 is also circular, and a diameter of the opening of the connection groove 223 is greater than a diameter of the heat absorbing end 41 of each of the thermal conduction members 40 so that the heat absorbing end 41 can be inserted into the connection groove 223. In addition, the connection groove 223 in the present embodiment penetrates through the outer portion 222 of the iron core 21 along the longitudinal direction of the iron core 21, and a length of the heat absorbing end 41 of each of the thermal conduction members 40 is substantially equal to a length of the connection groove 223 so that an area where each of the thermal conduction members 40 and the iron core 21 are in contact with each other can be increased.

Referring to FIG. 3, in each of the thermal conduction members 40, the cooling end 42 internally penetrates through the shell 10 to an end plate 11 of the motor 1 and extends out of the end plate 11. The heat dissipation device 50 is disposed outside of the end plate 11, and the cooling end 42 of each of the thermal conduction members 40 is connected to the heat dissipation device 50. More specifically, in the present embodiment, each of the thermal conduction members 40 can be a heat pipe, or a pillar or a rod made of copper. A working principle of the heat pipe is as below. When each of the thermal conduction members 40 is a heat pipe, a working fluid in the thermal conduction member 40 evaporates into a gas phase after the heat absorbing end 41 absorbs heat, and the working fluid in the gas phase is transferred to the cooling end 42 through a central space in the thermal conduction member 40 so that heat can be carried to the cooling end 42 by the working fluid that is evaporated into the gas phase. Afterwards, the working fluid is condensed into a liquid phase at the cooling end 42, and the working fluid is transferred back to the heat absorbing end 41 by the capillary action. Through a circulation of the working fluid, the heat is continuously transferred from the heat absorbing end 41 having a high temperature to the cooling end 42 having a low temperature 42. Through the thermal conduction members 40, heat of the stator 20 1 can be quickly transferred to the heat dissipation device 50 so that heat inside of the motor 1 can be directly transferred to the heat dissipation device 50 outside of the shell 10 of the motor 1. Therefore, a heat accumulation inside of the motor 1 can be prevented.

It should be noted that in the present embodiment, a plurality of thermal conduction member thru-holes 111 are disposed on the end plate 11 of the shell 10 of the motor 1, the thermal conduction member thru-holes 111 are corresponding in position to the thermal conduction members 40, and the thermal conduction members 40 penetrate through the thermal conduction member thru-holes 111. The thermal conduction members 40 and the thermal conduction member thru-holes 111 can be sealed through a suitable sealing technique. For example, a plurality of glues can be filled between the thermal conduction member thru-holes 111 and the thermal conduction members 40, or a sealing washer can be disposed between the thermal conduction member thru-holes 111 and the thermal conduction members 40 to form a sealing state. Therefore, a sealing property of the shell 10 of the motor 1 is not broken by disposing the thermal conduction members 40.

Referring to FIG. 3, in the present embodiment, the heat dissipation device 50 is disposed at one side of the motor 1 corresponding to the shaft 31 of the rotor 30. That is to say, the heat dissipation device 50 is disposed at one side of the motor 1 opposite to a power output side of the motor 1 so as to prevent the heat dissipation device 50, the shaft 31 of the motor 1, and a transmission system of the shaft 31 from mutual interference. In addition, in each of the thermal conduction members 40, the heat absorbing end 40 and the cooling end 41 are respectively arranged to be substantially parallel to the shaft 30 of the motor 1 and a central axis of the stator 20. Therefore, a bending extent of a flow path of the working fluid inside of the thermal conduction member 40 flowing between the heat absorbing end 41 and the cooling end 42 decreases, so that a heat exchange efficiency is improved.

It should be noted that in the present embodiment, the shaft 31 of the rotor 30 only protrudes from one side of the shell 10, but the present disclosure is not limited thereto. In other embodiments, the shaft 31 of the rotor 30 can protrude from two sides of the shell 10.

### Second Embodiment

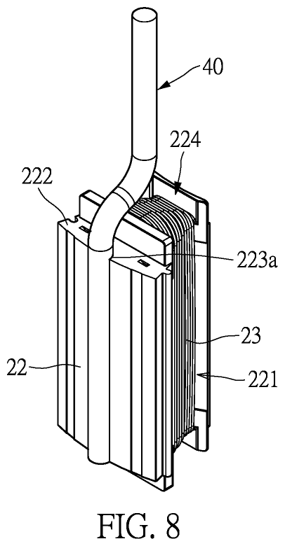

Referring to FIG. 7 and FIG. 8, FIG. 7 and FIG. 8 show the structure of the iron core block 22 of the second embodiment of the present disclosure. The basic structure in the second embodiment is similar to that of the first embodiment, and the similar technical characteristics will not be reiterated herein.

The difference between the iron core blocks 22 of the second embodiment and those of the first embodiment is as below. The connection groove 223a of the present embodiment is disposed at a groove of an outer surface of the outer portion 222 of the iron core 21, one side of the connection groove 223a facing away the rotor 30 is in an open state, and a width of the connection groove 223a corresponds to a radius of the heat absorbing end 41 of each of the thermal connection members 40 so that the heat absorbing end 41 of the corresponding one of the thermal connection members 40 is embedded in the connection groove 223a through an opening of the connection groove 223a. The configuration between the thermal conduction member 40 and the stator 20 in the present embodiment is not limited to the configuration in the first embodiment, and can be changed according to practical requirements.

### Third Embodiment

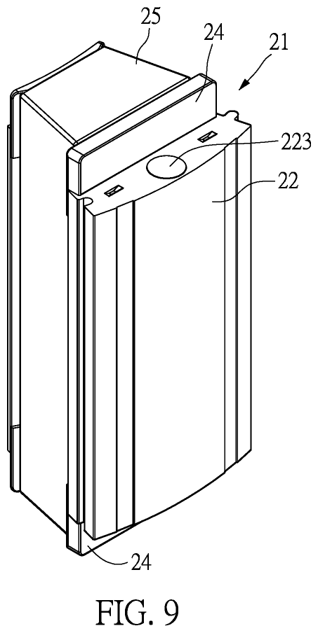

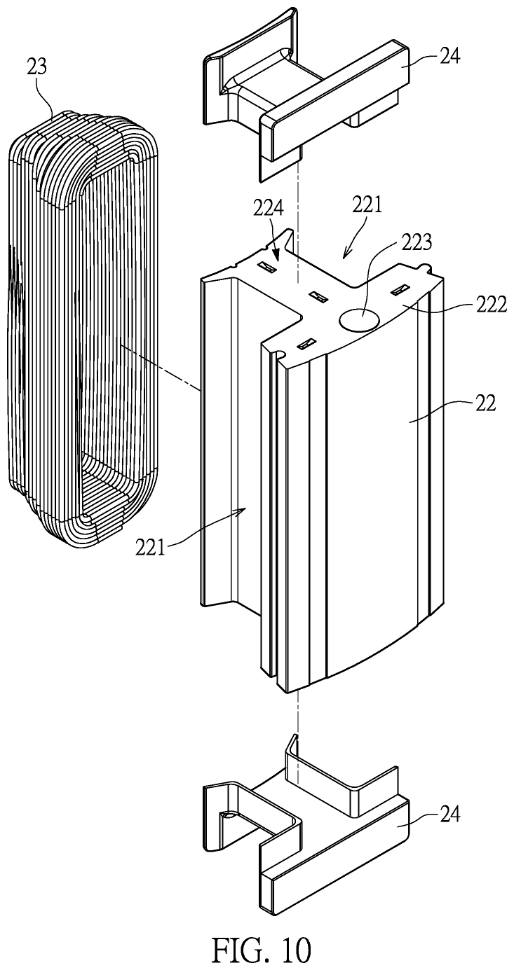

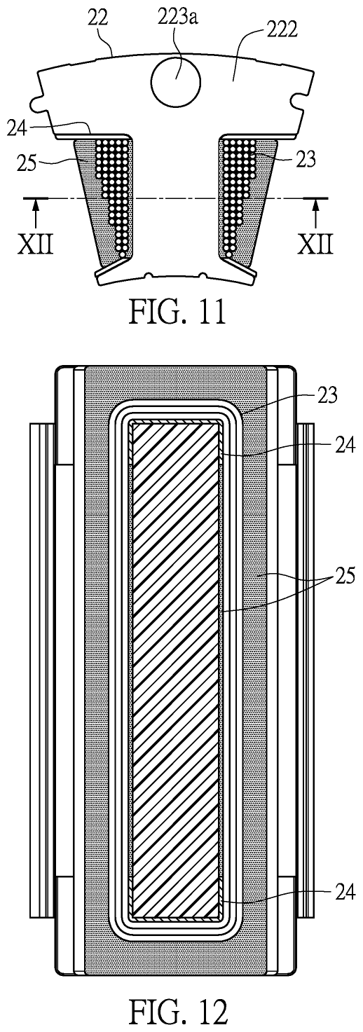

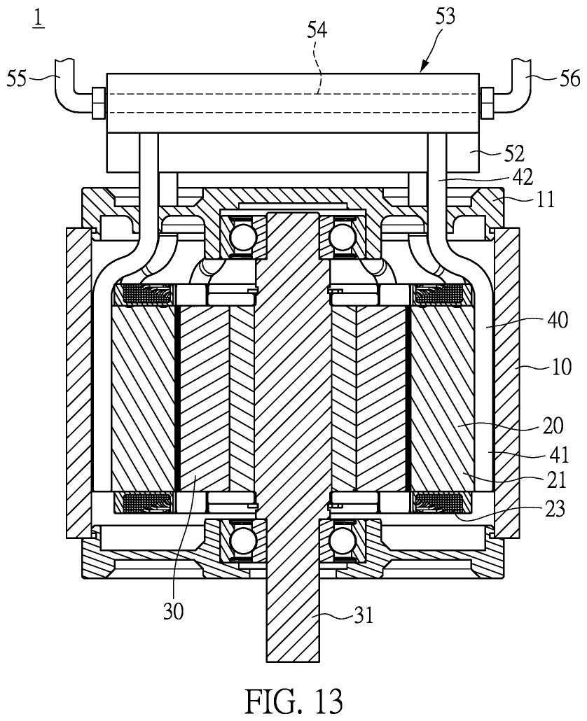

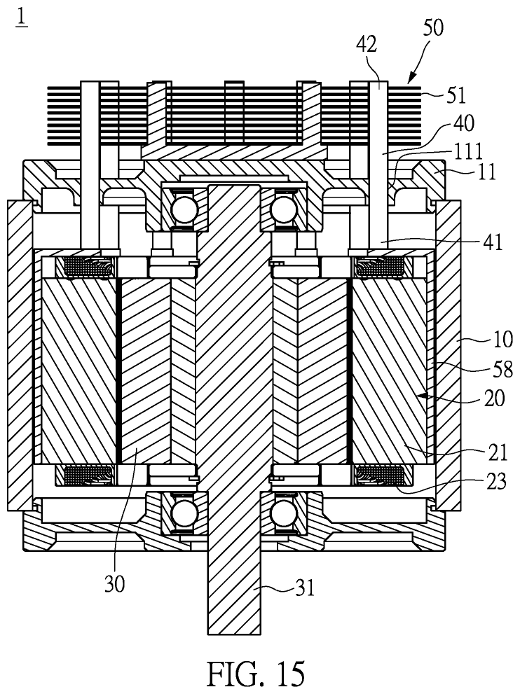

Referring to FIG. 9 to FIG. 12 for the third embodiment of the present disclosure, each of the winding portions 224 of iron core 21 is provided with two winding grooves 221, two insulation sleeves 24, and a coil 23. In the present embodiment, each of the winding portions 224 of the iron core 21 is further provided with a covering glue 25. The covering glue 25 covers an outer periphery of the coil 23 and is filled in a gap between the coil 23 and the winding grooves 221. The covering glue 25 can be made of insulating thermal conduction glue so that the covering glue 25 has an insulating property and a good thermal conductivity. Since the covering glue 25 provides insulation between an inner surface of the coil 23 and the iron core 21, heat of the coil 23 can be transferred to the iron core 21 through the covering glue 25, and an overheating issue of the coil 23 does not easily occur.

In each of the iron core blocks 22, each of the two insulation sleeves 24 is disposed at an outer periphery of the winding portion 24 and is disposed between the coil 23 and the winding grooves 221. Each of the insulation sleeves 24 is configured to provide insulation between the coil 23 and the winding portion 224, and the coil 23 and the winding portion 221 are spaced apart by the insulation sleeve 24 to form a gap to accommodate the covering glue 25. It should be noted that for the covering glue 25 to be filled in the gap between the coil 23 and the winding portion 221 of the iron core 21, the two insulation sleeves 24 are only disposed at two ends of the iron core 21, and a total length of the two insulation sleeves 24 is lower than a length of each of the winding grooves 221 along the longitudinal direction of the iron core 21. Therefore, the two insulation sleeves 24 are spaced apart with a distance, only two ends of the winding grooves 221 of the iron core 21 are partially covered by the two insulation sleeves 24, and a part of the winding grooves 221 between the two insulation sleeves 24 are not covered by the two insulation sleeves 24. In addition, during a winding process, the coil 23 surrounds the two insulation sleeves 24. Since each of the two insulation sleeves 24 has a thickness, each of the two insulation sleeves 24 can be a spacer between the coil 23 and the winding grooves 221. Therefore, a gap is formed between an innermost portion of the coil 23 and a portion of each of the winding grooves 221 that is not covered by the two insulation sleeves 24, so that the covering glue 25 can be filled in the gap between the coil 23 and the winding grooves 221.

It should be noted that although the two insulation sleeves 24 in the present embodiment are in an assembled structure having two members, the two insulation sleeves 24 in other embodiments can be integrally formed as a one-piece structure. For example, in each of the iron core blocks 22, the insulation sleeve 24 can be disposed at an outer periphery of the winding portion 224 in an over-molding manner, the insulation sleeve 24 is provided with a plurality of notches corresponding in position to the winding grooves 221 so that the winding grooves 221 are only partially covered by the insulation sleeve 24, and the covering glue 25 can be filled in the gap between the coil 23 and a part of the winding grooves 221 that is not covered by the insulation sleeve 24.

The present embodiment has effects as below. Heat of the coil 23 of the stator 20 can be transferred to the iron core 21 through the covering glue 25, and heat of the iron core 21 can be transferred to the heat dissipation device 50 outside of the iron core 21 through the thermal conduction members 40. Therefore, an internal temperature of the motor 1 can be decreased effectively.

### Fourth Embodiment

Referring to FIG. 13 for the fourth embodiment of the present disclosure, the difference between the present embodiment and the previous embodiments is that in each of the thermal conduction members 40, the cooling end 42 is connected to a thermal conduction block 52, and the cooling end 42 is connected to other heat dissipation device or thermal conduction device through the thermal conduction block 52. For example, in each of the thermal conduction members 40 of the present embodiment, the cooling end 42 is connected to the thermal conduction block 52 and the thermal conduction block 52 is connected to a heat dissipation device 53. The thermal conduction block 52 can be in a block shape and can be made of a metal having a high thermal conductivity (e.g., copper or aluminum). Therefore, heat of the cooling end 42 of each of the thermal conduction members 40 can be transferred to the thermal conduction block 52, the heat can be transferred to the heat dissipation device 53 through the thermal conduction block 52 afterwards, and the heat can be dissipated through the heat dissipation device 53.

It should be noted that in the present embodiment, the heat dissipation device 53 can be a water-cooling radiator. A device body of the heat dissipation device 53 can be made of a metal having a high thermal conductivity, and a cooling channel 54 can be disposed inside of the heat dissipation device 53. An inlet and an outlet of the cooling channel 53 are respectively connected to an inlet pipe 55 and an outlet pipe 56. Therefore, a cooling fluid can flow through the cooling channel 54 so that the heat dissipation device 53 can be cooled down. Naturally, the heat dissipation device 53 in the present embodiment is not limited to the water-cooling radiator and can be other types of radiators; the thermal conduction block 52 can be not in direct connection with the heat dissipation device 53 or the water-cooling radiator, and heat of the thermal conduction block 52 is transferred to another radiator to be dissipated, through another thermal conduction device.

In addition, referring to FIG. 14, FIG. 14 shows that the thermal conduction block 52 is connected to a heat dissipation device 57. The heat dissipation device 57 has a plurality of heat dissipation fins 571. Heat of the thermal conduction block 52 can be transferred to the heat dissipation device 57 and dissipated by the heat dissipation fins 571 afterwards.

The present embodiment has the following effects. The thermal conduction members 40 are not directly connected to the heat dissipation device. Instead, thermal conduction members 40 are indirectly connected to the heat dissipation device or other radiators. Therefore, it is not necessary for the heat dissipation device to be directly connected to the motor 1, so that a usage of a space inside of the motor 1 can be more adjustable.

### Fifth Embodiment

Referring to FIG. 15 for the fifth embodiment of the present disclosure, the difference between the fifth embodiment and the previous embodiments is that a thermal conduction component 58 is further provided. The thermal conduction members 40 are connected to the stator 20 through the thermal conduction component 58. Therefore, heat of the stator 20 is transferred to the thermal conduction members 40 through the thermal conduction component 58, and transferred to the heat dissipation device 50 through the thermal conduction members 40 to be dissipated afterwards.

In the present embodiment, the thermal conduction component 58 is a metal rack made of a metal having a high thermal conductivity (e.g., copper or aluminum). One end of the thermal conduction component 58 is connected to an outer surface of the iron core 21, and another end of the thermal conduction component 58 is connected to the heat absorbing end 41 of each of the heat dissipation members 40. Therefore, heat of the stator 20 can be transferred to the thermal conduction members 40 through the thermal conduction component 58.

In the present embodiment, the stator 20 is connected to the thermal conduction members 40 through the thermal conduction component 58, so that a usage of a space of the stator 20 inside of the motor 1 and the thermal conduction members 40 can be simplified. In addition, a bending extent of the thermal conduction members 40 is decreased so that a structure and an assembly process of the motor 1 can be simplified. Through the thermal conduction component 58, the iron core blocks 22 can be connected to the same one of the thermal conduction members 40 so that the number of the thermal conduction members 40 can be reduced.

In conclusion, the heat of the stator 20 inside of the motor 1 can be transferred to the heat dissipation device 50 disposed outside of the shell 10 through the thermal conduction members 40 so that the temperature of the motor 1 decreases quickly to prevent the motor 1 from accumulating heat therein. In addition, the thermal conduction members 40 of the present disclosure are configured to transfer heat through a fluid in a sealed space, and the fluid changes from a liquid phase to a gas phase or the gas phase to the liquid phase in a closed cycle, so that the shell 10 of the motor 1 can be maintained in a sealed state and the temperature of the motor 1 can be decreased through the closed cycle.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A closed-cycle heat dissipation structure of a motor, wherein the motor includes a shell, a stator disposed inside of the shell, and a rotor internally penetrating through the stator, the closed-cycle heat dissipation structure comprising:
a plurality of thermal conduction members each defining two ends thereof as a heat absorbing end and a cooling end, wherein the heat absorbing ends of the thermal conduction members are connected to the stator, and wherein the cooling ends of the thermal conduction members penetrate through the shell of the motor and extend out of the shell; and
a heat dissipation device disposed outside of the shell, wherein the cooling ends of the thermal conduction members are connected to the heat dissipation device.

2. The closed-cycle heat dissipation structure according to claim 1, wherein the stator has an iron core surrounding an outer periphery of the rotor, wherein the iron core has a plurality of winding portions at one side of the iron core facing toward the rotor and a plurality of coils surrounding the winding portions, and wherein the iron core has an outer portion at one side of the iron core corresponding in position to the winding portions, and the heat absorbing ends of the thermal conduction members are connected to the outer portion.

3. The closed-cycle heat dissipation structure according to claim 2, wherein the iron core has a plurality of iron core blocks assembled into a ring shape, and the iron core blocks surround an outer periphery of the rotor, and wherein each of the iron core blocks is provided with the winding portion, and each of the iron core blocks has the outer portion at one side thereof corresponding in position to the winding portion.

4. The closed-cycle heat dissipation structure according to claim 3, wherein the thermal conduction members are a plurality of heat pipes, the iron core has a plurality of connection grooves at the outer portions of the iron core, and the heat absorbing ends of the thermal conduction members are connected to the connection grooves, wherein the shell has an end plate at one end of the shell corresponding in position to a shaft of the rotor, and the cooling ends of the thermal conduction members penetrate through the end plate and extend out of the end plate, and wherein the heat dissipation device is disposed outside of the end plate, and the cooling ends of the thermal conduction members are connected to the heat dissipation device.

5. The closed-cycle heat dissipation structure according to claim 4, wherein each of the connection grooves is disposed at the outer portion of the iron core along a longitudinal direction of the iron core, and in each of the thermal conduction members, the heat absorbing end and the cooling end are arranged to be parallel to a central axis of the rotor.

6. The closed-cycle heat dissipation structure according to claim 4, wherein a thermal conduction glue or a thermal conduction paste is filled between an outer periphery of the iron core and an inner side wall of the shell.

7. The closed-cycle heat dissipation structure according to claim 4, wherein the cooling ends of the thermal conduction members are connected to a thermal conduction block, and the cooling ends of the thermal conduction members are connected to the heat dissipation device through the thermal conduction block.

8. The closed-cycle heat dissipation structure according to claim 4, wherein each of the winding portions of the iron core has a covering glue, the covering glue covers an outer periphery of the winding portion and the coil, and the covering glue is filled in a gap between the coil and the winding portion.

9. The closed-cycle heat dissipation structure according to claim 8, wherein each of the winding portions is provided with at least one insulation sleeve, the at least one insulation sleeve surrounds an outer periphery of the corresponding one of the winding portions and partially covers two winding grooves of the corresponding one of the winding portions so that a gap is maintained between an inner surface of the coil and a portion of each of the two winding grooves that is not covered by the at least one insulation sleeve.

10. The closed-cycle heat dissipation structure according to claim 3, further comprising a thermal conduction component connected between the iron core and the heat absorbing ends of the thermal conduction members so that heat of the iron core can be transferred to the heat absorbing ends of the thermal conduction members through the thermal conduction component.
